(19) United States
(12) Patent Application Publication
(10) Pub. No.: US 2016/0372798 A1
(43) Pub. Date: Dec. 22, 2016

(54) NON-AQUEOUS ELECTROLYTE SECONDARY BATTERY

(71) Applicant: TOYOTA JIDOSHA KABUSHIKI KAISHA, Toyota-shi (JP)

(72) Inventor: Kenta ISHII, Nisshin-shi (JP)

(73) Assignee: TOYOTA JIDOSHA KABUSHIKI KAISHA, Toyota-shi (JP)

(21) Appl. No.: 14/902,206

(22) PCT Filed: Jun. 11, 2014
(86) PCT No.: PCT/IB2014/001239

§ 371 Date: Dec. 30, 2015

(30) Foreign Application Priority Data
Jul. 1, 2013 (JP) 2013-138310

(51) Int. Cl. H01M 10/42; H01M 4/36; H01M 10/0587; H01M 10/0525; H01M 10/0567; H01M 4/583; H01M 2/34

(52) U.S. Cl. CPC H01M 10/4235; H01M 4/583; H01M 4/366; H01M 2/345; H01M 10/0525; H01M 10/0567; H01M 10/0587; H01M 2010/4292

(57) ABSTRACT

A non-aqueous electrolyte secondary battery includes an electrode body, a non-aqueous electrolyte, and a battery case. The electrode body has a cathode and an anode. The cathode has a cathode active substance. The anode has an anode active substance. A relationship between an irreversible capacity of the anode and an irreversible capacity of the cathode satisfies Uc<Ua. Where, Ua is the irreversible capacity of the anode, which is a product of multiplying a unit irreversible capacity of the anode per 1 g of the anode active substance by a mass of the anode active substance, and Uc is the irreversible capacity of the cathode, which is a product of multiplying a unit irreversible capacity of the cathode per 1 g of the cathode active substance by a mass of the cathode active substance.

### BACKGROUND OF THE INVENTION

1. Field of the Invention

This invention relates to a non-aqueous electrolyte secondary battery. More specifically, this invention relates to a non-aqueous electrolyte secondary battery that includes an anode having a high irreversible capacity.

2. Description of Related Art

In recent years, non-aqueous electrolyte secondary batteries such as lithium ion secondary batteries and nickel hydrogen batteries have been used as power sources for portable electronic equipment and transportation equipment. In particular, lithium ion secondary batteries, which can achieve high energy density while being light weight, can be advantageously used as high output motive power sources in electric vehicles, hybrid vehicles, and so on.

For such non-aqueous electrolyte secondary batteries, research has been carried out into further improving cycle characteristics in order to improve battery performance. Features relating to this have been disclosed in Japanese Patent Application Publication No. 09-017431 (JP 09-017431 A). JP 09-017431 A indicates that by using a carbon material on which a specific organic material is supported in an anode, irreversible capacity can be reduced and cycle characteristics can be improved.

### SUMMARY OF THE INVENTION

Some non-aqueous electrolyte secondary batteries are used in modes whereby high rate discharging (rapid discharging) is frequently repeated while the battery is in a low state of charge (SOC). Examples of batteries designed for such modes of use include batteries installed as power sources in vehicles such as plug-in hybrid vehicles. However, non-aqueous electrolyte secondary batteries exhibit extremely high internal resistance in low SOC regions (for example regions in which the SOC is 30% or lower). This means that it is difficult to ensure input-output characteristics.

This invention provides a non-aqueous electrolyte secondary battery able to achieve both durability (for example, cycle characteristics and high temperature storage properties) and input-output characteristics across a wide range of SOC regions (and in a low SOC region in particular) at high levels.

According to the findings of the inventor of this invention, the increase in internal resistance in a low SOC region is caused mainly by the cathode. More specifically, the current in the cathode decreases dramatically in a low SOC region (during the final stage of discharging), meaning that a decrease in the voltage of the battery is caused by the cathode. As a result, the reactive resistance of the cathode increases and the input-output characteristics can deteriorate. Therefore, the inventor of this invention considered shifting the potential range (the operating potential) of the cathode used for charging and discharging to the high potential side. FIG. 1 is a diagram showing the concept of this invention, with the vertical axis indicating potential and the horizontal axis indicating capacity. In addition, (1) is a chart for an anode according to a comparative invention, and (2) is a chart for an anode according to this invention. That is, the inventor of this invention considered that by shifting the potential of the anode from (1) to (2), it would be possible to maintain the potential of the cathode at a high level even in a low SOC region and therefore reduce the reactive resistance of the battery. In addition, as a result of diligent research, the inventor of this invention found a means by which this problem can be solved, and thereby completed this invention.

A non-aqueous electrolyte secondary battery according to one aspect of this invention includes an electrode body, a non-aqueous electrolyte and a battery case. The electrode body has a cathode and an anode. The cathode has a cathode active substance. The anode has an anode active substance. A unit irreversible capacity of the anode per 1 g of the anode active substance is within a range from 15 mAh/g to 35 mAh/g. A relationship between an irreversible capacity of the anode and an irreversible capacity of the cathode satisfies Uc<Ua. Where, Ua is the irreversible capacity of the anode, which is a product of multiplying a unit irreversible capacity of the anode per 1 g of the anode active substance by a mass of the anode active substance, and Uc is the irreversible capacity of the cathode, which is a product of multiplying a unit irreversible capacity of the cathode per 1 g of the cathode active substance by a mass of the cathode active substance. The battery case houses the electrode body and the non-aqueous electrolyte. The non-aqueous electrolyte secondary battery is, for example, a lithium ion battery.

According to one aspect of this invention, by setting the irreversible capacity of the anode Ua to be greater than the irreversible capacity of the cathode Uc, the potential of the anode (vs. Li/Li⁺) shows a relative increase. Therefore, the potential of the cathode during the final stage of discharging shifts to the high potential side compared to a conventional cathode for the same current and voltage. As a result, a decrease in the voltage of the battery in a low SOC region is dependent upon the anode, and excellent input-output characteristics are achieved. In addition, by setting the unit irreversible capacity of the anode to fall within the range mentioned above, a high level of durability (for example, high temperature storage properties) can be maintained. In this way, it is possible to provide a battery which exhibits both excellent input-output characteristics in a low SOC region and high durability.

Moreover, “unit irreversible capacity” in the specification means the irreversible capacity per 1 g of active substance. This value can be measured by using a method involving the use of a conventional publicly available two electrode type cell. For example, when measuring the unit irreversible capacity of the anode (the anode active material), a working electrode is first prepared by cutting the anode (the anode active substance layer) being measured to a prescribed size. Next, a laminate is prepared by disposing this working electrode so as to face a metallic lithium counter electrode via a separator. A two electrode type cell is then constructed by housing this laminate in a case together with a non-aqueous electrolyte. Next, this cell is charged at a constant current of 0.1 C at a temperature of 25° C. until the terminal voltage between the working electrode and the counter electrode reaches 0.01 V, then charged at a constant voltage until the total charging time reaches 14 hours, then allowed to rest for 10 minutes, and then discharged at a constant current of 0.1 C until the terminal voltage between the working electrode and the counter electrode reaches 1.5 V. Here, the unit irreversible capacity of the anode can be determined by subtracting the CC discharging capacity for the first cycle from the CCCV charging capacity for the first cycle, and then dividing by the mass of the anode active substance used in the measurement.

In a non-aqueous electrolyte secondary battery according to one aspect of this invention, a ratio of a charging capacity of the anode to a charging capacity of the cathode satisfies a following relationship: 1.2≦Ca/Cc≦1.5. Where, Ca is the charging capacity of the anode, which is a product of multiplying a unit charging capacity of the anode per 1 g of the anode active substance by the mass of the anode active substance, and Cc is the charging capacity of the cathode, which is a product of multiplying a unit charging capacity of the cathode per 1 g of the cathode active substance by the mass of the cathode active substance. The ratio of the cathode capacity to the anode capacity in the battery directly influences the capacity (or the irreversible capacity) of the battery and the energy density of the battery, and according to the usage conditions of the battery (for example, rapid charging or discharging), the charge carrier can become fixed on the surface of the anode (for example, lithium can precipitate on the surface of the anode), thereby causing the thermal stability to deteriorate. By setting the capacity ratio of the cathode and the anode to fall within the range mentioned above, good battery characteristics, such as energy density, can be maintained and the charge carrier can be satisfactorily prevented from becoming fixed on the anode. Therefore, the operating effect of this invention can be exhibited to a high level.

Moreover, “unit charging capacity” in the specification means the charging capacity per 1 g of active substance. The unit charging capacity of the anode (the anode active substance) can be determined by dividing the CCCV charging capacity for the first cycle, which is obtained by the above-mentioned two electrode type cell measurement, by the mass of the anode active substance used in the measurement. In addition, the unit charging capacity of the cathode (the cathode active substance) can be measured in the same way as described above for the anode. Specifically, a working electrode is first prepared by cutting the cathode (the cathode active substance layer) being measured to a prescribed size, in the same way as described above for the anode. Next, a laminate is prepared by disposing this working electrode so as to face a metallic lithium counter electrode via a separator. A two electrode type cell is then constructed by housing this laminate in a case together with a non-aqueous electrolyte. Next, this cell is charged at a constant current of 0.1 C at a temperature of 25° C. until the terminal voltage between the working electrode and the counter electrode reaches 4.2 V, then charged at a constant voltage until the total charging time reaches 14 hours, then allowed to rest for 10 minutes, and then discharged at a constant current of 0.1 C until the terminal voltage between the working electrode and the counter electrode reaches 3.0 V. Here, the unit charging capacity of the cathode can be determined by dividing the CCCV charging capacity for the first cycle by the mass of the cathode active substance used in the measurement.

In a non-aqueous electrolyte secondary battery according to one aspect of this invention, the battery case may be provided with a current interrupt device (CID) that is configured to interrupt a current of the non-aqueous electrolyte secondary battery when the pressure inside the battery case exceeds a pre-set pressure. The non-aqueous electrolyte may contain a gas generating agent capable of generating a gas through decomposition when a SOC of the battery is within a range from 115% to 140%. When the battery is in an overcharged state and the SOC (or oxidation potential) reaches the prescribed value, the gas generating agent contained in the battery undergoes oxidative decomposition at the cathode and typically generates hydrogen ions (H+). In addition, these hydrogen ions diffuse into the non-aqueous electrolyte and are reduced at the anode, thereby generating hydrogen gas (H2). Because the pressure inside the battery increases as a result, the CID is deployed. By setting the SOC at which the gas generating agent decomposes to fall within the range mentioned above, the CID deploys rapidly when overcharging occurs. In addition, the resistance during normal usage decreases and excellent battery characteristics (cycle characteristics) are maintained over a long period of time.

In a non-aqueous electrolyte secondary battery according to one aspect of this invention, the anode active substance may be a particulate non-crystalline carbon-coated graphite, and properties of the anode active substance satisfies the following relationship: −0.03≦ log(R×S_{BET})≦0.18. Where, R is a R-value of the particulate non-crystalline carbon-coated graphite, as measured by Raman spectroscopy, and S_{BET} is a BET specific surface area of the particulate non-crystalline carbon-coated graphite, as measured using a nitrogen adsorption method. By setting the properties of the anode active substance to fall within the range mentioned above, the unit charging capacity range (mAh/g) of the anode can be satisfactorily achieved.

Moreover, “R-value” in the specification means the ratio of the intensity I_{G} of a Raman band at approximately 1580 cm⁻¹ (a G peak) relative to the intensity I_{D} of a Raman band at approximately 1360 cm⁻¹ (a D peak) (R=I_{D}/I_{G}) in a Raman spectrum obtained by Raman spectroscopy using an argon laser having a wavelength of 514.5 nm. In addition, “BET specific surface area” means a value obtained by subjecting the quantity of gas adsorbed, as measured by a gas absorption method using nitrogen (N₂) gas as the adsorbate (a fixed volume type adsorption method), to analysis using a BET method (for example, a BET multipoint method).

In a non-aqueous electrolyte secondary battery according to one aspect of this invention, the electrode body is a flat wound electrode body, and the thickness T of the flat part of the wound electrode body is 20 mm or higher. According to the findings of the inventor of this invention, the temperature difference inside the electrode body during overcharging can increase in an electrode body in which the thickness T of the flat part is 20 mm or higher. Therefore, measures designed to deal with overcharging are particularly important. According to the features disclosed here, it is possible to achieve both battery characteristics during normal usage and reliability during overcharging (resistance to overcharging) at high levels. Therefore, in cases where the electrode body is thick, it is particularly preferable to use the above-mentioned flat part thickness. Moreover, “the thickness T of the flat part” in the specification means the average thickness of flat parts in the flat wound electrode body.

As mentioned above, a non-aqueous electrolyte secondary battery according to one aspect of this invention achieves both input-output characteristics in a low SOC region and durability at high levels. Furthermore, it is possible to achieve high reliability whereby the CID deploys properly when overcharging occurs. Therefore, a non-aqueous electrolyte secondary battery according to one aspect of this invention utilizes these characteristics and can be advantageously used as a power source (a motive power source) for a plug-in hybrid vehicle, hybrid vehicle, or the like.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory drawing showing the relationship between potential and capacity in order to explain the concept of this invention;

FIG. 2 is a schematic diagram showing the structure of a cross section of a non-aqueous electrolyte secondary battery according to one embodiment;

FIG. 3 is a graph showing the relationship between the unit irreversible capacity of the anode (mAh/g) and the capacity degradation gradient (%/√(day));

FIG. 4 is a graph showing the relationship between a property (log(R×S_{BET})) of the anode active substance and the unit irreversible capacity of the anode (mAh/g);

FIG. 5 is a graph showing the relationship between the proportion of CHB when the total quantity of the gas generating agent is taken to be 1 and the SOC (%) at which oxidative decomposition starts;

FIG. 6 is a graph showing the relationship between the added quantity (mass %) of the gas generating agent and the surface temperature (° C.) of the battery; and

FIG. 7 is a graph showing changes (changes over time) in the temperature of the wound electrode body during overcharging.

### DETAILED DESCRIPTION OF EMBODIMENTS

Preferred embodiments of this invention will now be explained. Moreover, matters which are essential for carrying out the invention and which are matters other than those explicitly mentioned in this specification (for example, constituent components of the battery that do not characterize this invention, or ordinary production processes) are matters that a person skilled in the art could understand to be matters of design on the basis of the related art in this technical field. This invention can be carried out on the basis of the matters disclosed in this specification and common general technical knowledge in this technical field.

The non-aqueous electrolyte secondary battery disclosed here has a constitution whereby an electrode body and a non-aqueous electrolyte are housed in a battery case. For example, a light weight metal such as aluminum can be preferably used as the battery case. In a preferred aspect, the above-mentioned battery case is provided with a CID that deploys when the pressure inside the case increases. In this way, it is possible to provide a high capacity battery having excellent resistance to overcharging.

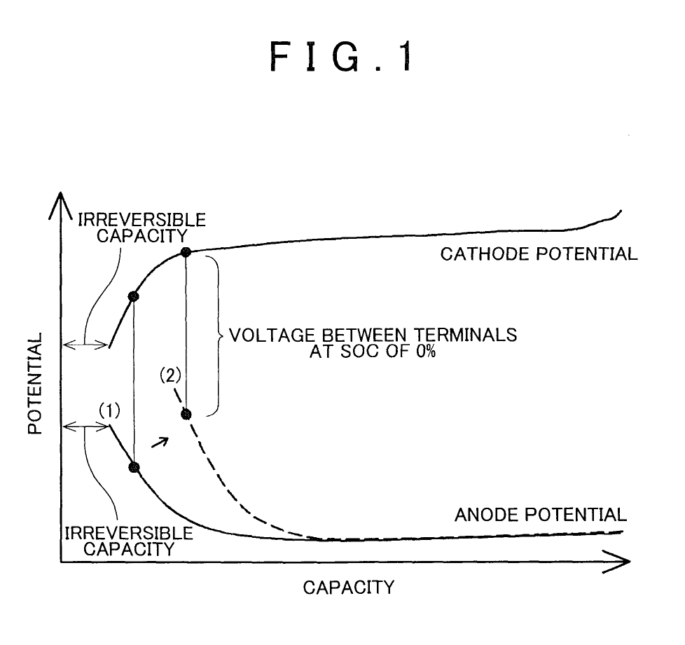

The electrode body is provided with a cathode having a cathode active substance and an anode having an anode active substance, and is characterized in that the irreversible capacity of the anode Ua (mAh) is greater than the irreversible capacity of the cathode Uc (mAh) (that is, Uc<Ua). In this way, a decrease in the voltage of the battery during the final stage of, discharging is dependent upon the anode and it is possible to achieve high input-output characteristics even in a low SOC region (see FIG. 1). Moreover, the “irreversible capacity” is calculated from the product of the unit irreversible capacity (mAh/g) and the mass (g) of the active substance. Therefore, the irreversible capacities of the cathode and anode can be adjusted by adjusting the unit irreversible capacity of the active substance (that is, the properties of the active substance) and/or the mass of active substance used.

The anode is not particularly limited as long as an anode active substance is contained therein, but is typically obtained by fixing an anode active substance layer that contains an anode active substance on an anode current collector. Such an anode can be produced by using, for example, a method such as that described below. First, a paste-like or slurry-like composition is prepared by dispersing an anode active substance and a binder in an appropriate solvent (for example, water or N-methyl-2-pyrrolidone). Next, this composition is applied to the surface of an anode current collector, and the solvent is removed by drying. In this way, it is possible to produce an anode having an anode active substance layer on an anode current collector. An electrically conductive member consisting of a metal exhibiting good electrical conductivity (for example, copper, nickel, titanium or stainless steel) can be preferably used as the anode current collector.

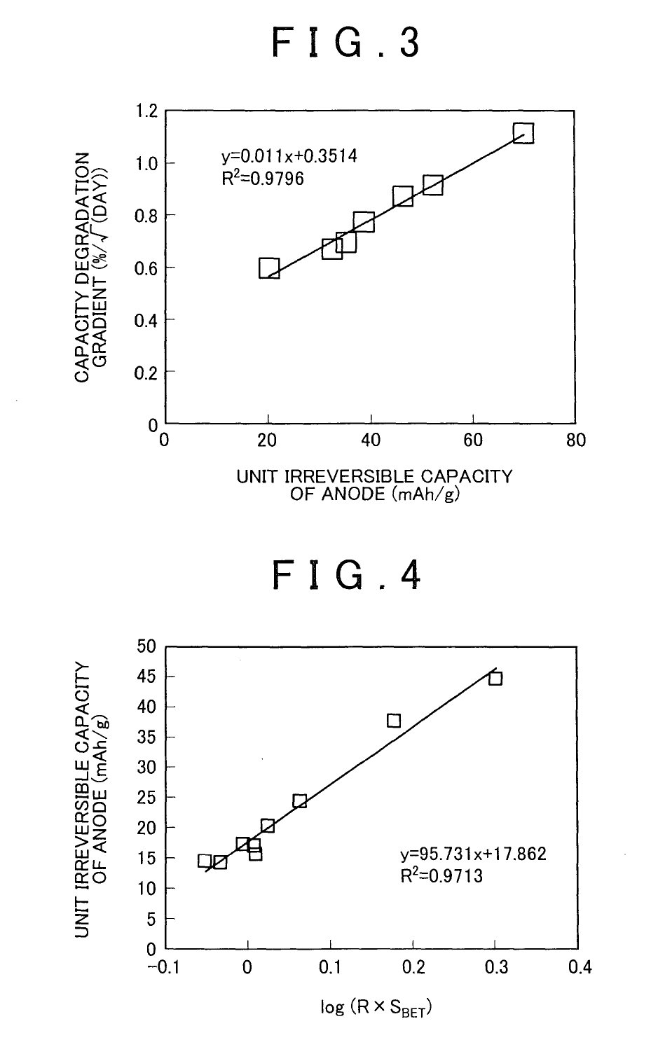

A substance having a unit irreversible capacity within a range from 15 mAh/g to 35 mAh/g per 1 g of substance can be used as the anode active substance. By achieving a higher unit irreversible capacity than conventional products, for example not lower than or equal 15 mAh/g (typically not lower than or equal 16 mAh/g, for example not lower than or equal 20 mAh/g, and preferably not lower than or equal 22 mAh/g), it is possible to improve the input-output characteristics of the battery (and especially the input-output characteristics in a low SOC region). However, according to the findings of the inventor of this invention, simply increasing the unit irreversible capacity can cause a deterioration in durability. FIG. 3 is a graph showing the relationship between the unit irreversible capacity of the anode and the capacity degradation gradient. Specifically, lithium ion secondary batteries were first constructed using 7 types of anode active substance that differed only in terms of unit irreversible capacity, and these batteries were then subjected to cycle tests (1000 cycles at 25° C.). Moreover, other conditions, such as the masses of the anode active substances, were all identical. The capacities of the batteries after the cycle test were extrapolated, and the capacity degradation gradients (%/√(day)) were calculated from the square root law. As shown in FIG. 3, the capacity degradation gradient increases as the unit irreversible capacity of the anode increases. This is because in batteries in which the unit irreversible capacity of the anode is high, a large quantity of charge carrier is trapped inside the anode active substance, and the effective quantity of charge carrier (for example, lithium ions) able to be used for charging and discharging decreases. Therefore, in the feature disclosed here, the unit irreversible capacity is not higher than 35 mAh/g (typically not higher than 34 mAh/g). In this way, it is possible to maintain or improve the durability of the battery (for example, the cycle characteristics or high temperature storage properties). Therefore, the battery disclosed here can achieve both input-output characteristics across a wide range of SOC regions and durability.

The unit irreversible capacity of the anode can be adjusted using a variety of methods. Specifically, the unit irreversible capacity of the anode can be adjusted by controlling the R-value, as measured by Raman spectroscopy, and the BET specific surface area S_{BET} (m²/g), as measured by a nitrogen adsorption method. FIG. 4 shows the relationship between the unit irreversible capacity of the anode and the above-mentioned property (log(R×S_{BET})). In cases where the properties of the anode satisfy the following relationship: −0.03≦ log(R×S_{BET})≦0.18, as shown here, the unit irreversible capacity of the anode can be adjusted to a preferred value within the range 15 mAh/g to 35 mAh/g. Moreover, the R-value can be adjusted by, for example, mixing two or more types of (crystalline) material having different degrees of graphitization, such as those shown below. In addition, the S_{BET} value can be adjusted by, for example, pulverizing or sieving (sifting).

The anode active substance is not particularly limited as long as the above-mentioned range for the unit irreversible capacity of the anode is satisfied, and one or more types of conventional substance that can be used as anode active substances in non-aqueous electrolyte secondary batteries can be used. A preferred example thereof is a mixture of two or more types of carbon material having different crystallinities (for example, two or more types of carbon material selected from among graphite, slightly graphitizable carbon (hard carbon), readily graphitizable carbon (soft carbon), carbon nanotubes, and the like). Of these, non-crystalline carbon-coated graphite, which is obtained by forming a coating film consisting of a non-crystalline carbon material (for example, readily graphitizable carbon) on the surface of graphite, can be advantageously used. By coating graphite having a high theoretical capacity with a non-crystalline carbon having a high charge carrier storage/discharge speed, it is possible to achieve both high energy density and high output density.

This type of non-crystalline carbon-coated graphite can be produced using a conventional publicly available method. For example, a graphite material and a readily graphitizable carbon material are first prepared as raw materials. The graphite material can be natural graphite such as aggregated graphite or flaky graphite, an artificial graphite obtained by firing a carbon precursor, or a graphite obtained by subjecting the above-mentioned types of graphite to a process such as pulverizing or pressing. In addition, the readily graphitizable carbon material can be coke (pitch coke, petroleum coke, or the like), mesophase pitch-based carbon fibers, thermal composition vapor phase grown carbon fibers, or the like. Next, the readily graphitizable carbon material is deposited on the surface of the graphite material by a conventional publicly available method, for example a gas phase method such as chemical vapor deposition (CVD) or a liquid or solid phase method. In addition, by carbonizing this composite material through firing, it is possible to produce a non-crystalline carbon-coated graphite. Moreover, the R-value can be adjusted by adjusting, for example, the types of raw materials used, the blending proportions thereof, the firing temperature, and so on.

For example, a polymer material such as a styrene-butadiene rubber (SBR), poly(vinylidene fluoride) (PVdF) or polytetrafluoroethylene (PTFE) can be preferably used as the binder. In addition to the materials mentioned above, it is possible to use a variety of additives (for example, thickening agents, dispersing agents, electrically conductive materials, and the like) as long as the effect of this invention is not significantly impaired. For example, it is possible to use carboxymethyl cellulose (CMC), methyl cellulose (MC), or the like as a thickening agent.

The proportion of the anode active substance relative to the overall anode active substance layer should be approximately 50 mass % or higher, and is preferably 90 to 99.5 mass % (for example, 95 to 99 mass %). In cases where a binder is used, the proportion of the binder relative to the overall anode active substance layer can be, for example, approximately 0.5 to 10 mass %, and is preferably 1 to 5 mass %. In cases where a variety of additives, such as thickening agents, are used, the proportion of the additives relative to the overall anode active substance layer can be, for example, approximately 0.5 to 10 mass %, and is preferably 1 to 5 mass %.

The mass of anode active substance used per battery should be decided so that the relationship of the above-mentioned irreversible capacities (Uc<Ua) is satisfied and so that the desired energy density is achieved. For example, the mass of anode active substance per unit area of anode current collector can be approximately 5 to 20 mg/cm² (and typically 10 to 15 mg/cm²) per surface.

The cathode is not particularly limited as long as a cathode active substance is contained therein, but is typically obtained by fixing a cathode active substance layer that contains the cathode active substance on a cathode current collector. Such a cathode can be produced by using, for example, a method such as that described below. First, a paste-like or slurry-like composition is prepared by dispersing a cathode active substance, an electrically conductive material and a binder in an appropriate solvent (for example, N-methyl-2-pyrrolidone). Next, this composition is applied to the surface of a cathode current collector, and the solvent is removed by drying. In this way, it is possible to produce a cathode having a cathode active substance layer on a cathode current collector. An electrically conductive member consisting of a metal exhibiting good electrical conductivity (for example, aluminum, nickel, titanium or stainless steel) can be preferably used as the cathode current collector.

The cathode active substance is not particularly limited, and it is possible to use one or more conventional substances that can be used as cathode active substances in non-aqueous electrolyte secondary batteries. Preferred examples thereof include layered spinel type lithium complex oxides (for example, LiNiO₂, LiCoO₂, LiFeO₂, LiMn₂O₄, LiNi_{0.5}Mn_{1.5}O₄, LiCrMnO₄, LiFePO₄, or the like). Of these, a lithium-nickel-cobalt-manganese complex oxide which contains Li, Ni, Co and Mn as constituent elements and which has a layered structure (typically a layered rock salt structure belonging to the hexagonal system), (for example, LiNi_{1/3}Co_{1/3}Mn_{1/3}O₂) can be preferably used due to being able to exhibit excellent thermal stability and high energy density.

For example, a carbon material such as carbon black (typically acetylene black or ketjen black), active carbon, graphite or carbon fibers can be preferably used as the electrically conductive material. For example, a polymer material, such as a vinyl halide-based resin such as poly(vinylidene fluoride) (PVdF); or a poly(alkylene oxide) such as poly(ethylene oxide) (PEO) can be preferably used as the binder. In addition to the materials mentioned above, it is possible to use a variety of additives (for example, inorganic compounds that generate gases upon overcharging, dispersing agents, thickening agents, and the like) as long as the effect of this invention is not significantly impaired.

The proportion of the cathode active substance relative to the overall cathode active substance layer should be approximately 60 mass % or higher (typically 60 to 99 mass %) and is preferably approximately 70 to 95 mass %. In cases where an electrically conductive material is used, the proportion of the electrically conductive material relative to the overall cathode active substance layer can be approximately 1 to 20 mass %, and is preferably approximately 2 to 10 mass %. In cases where a binder is used, the proportion of the binder relative to the overall cathode active substance layer can be, for example, approximately 0.5 to 10 mass %, and is preferably 1 to 5 mass %.

The mass of cathode active substance used per battery should be decided so that the relationship of the above-mentioned irreversible capacities (Uc<Ua) is satisfied and so that the desired energy density is achieved. For example, the mass of cathode active substance per unit area of cathode current collector can be approximately 5 to 35 mg/cm² (and typically 10 to 30 mg/cm²) per surface.

In a preferred aspect disclosed here, the ratio of the charging capacity of the anode Ca (mAh) and the charging capacity of the cathode Cc (mAh) (Ca/Cc) satisfies the following relationship: 1.2≦(Ca/Cc)≦1.5. Moreover, the “charging capacity” can be calculated from the product of the unit charging capacity per 1 g of active substance (mAh/g) and the mass (g) of the active substance. By setting this capacity ratio (Ca/Cc) to be 1.2 or higher (typically 1.25 or higher), it is possible to prevent the charge carrier from becoming fixed on the anode during overcharging (for example, preventing lithium from precipitating on the surface of the anode). In this way, it is possible to obtain a battery having excellent thermal stability. In addition, by setting this capacity ratio (Ca/Cc) to be 1.5 or lower (typically 1.45 or lower), it is possible to keep the potential of the anode at a relatively low level during initial charging and it is also possible to advantageously form a film consisting of decomposition products derived from the non-aqueous electrolyte (a so-called solid electrolyte interface (SEI) film) on the surface of the anode. In this way, it is possible to greatly stabilize the interface between the anode active substance and the non-aqueous electrolyte and it is also possible to suppress reductive decomposition of the non-aqueous electrolyte to a high degree during subsequent charging and discharging. Therefore, the battery disclosed here can realize a battery which exhibits excellent durability and which can achieve high energy density over a long period of time.

A separator can typically be used as an insulating layer for preventing direct contact between the above-mentioned cathode and the above-mentioned anode. The separator is not particularly limited, and can be any separator that insulates the cathode active substance layer from the anode active substance layer and exhibits a non-aqueous electrolyte retention function or a shutdown function. Preferred examples thereof include porous resin sheets (films) consisting of resins such as polyethylene (PE), polypropylene (PP), polyesters, cellulose and polyamides. This type of porous resin sheet may have a single layer structure or a laminated structure having two or more layers (for example, a three layer structure obtained by laminating a PP layer on both surfaces of a PE layer).

In a preferred aspect, the separator has a constitution whereby a porous heat-resistant layer is provided on one surface or both surfaces (typically one surface) of the above-mentioned porous resin sheet. This type of porous heat-resistant layer may be a layer that contains an inorganic material (for example an inorganic filler such as alumina particles) and a binder. Alternatively, this type of porous heat-resistant layer may be a layer that contains insulating resin particles (for example particles of polyethylene, polypropylene, or the like). In this way, the separator does not soften or melt and can retain its shape (a slight degree of deformation is allowed) even in cases where, for example, the temperature inside the battery increases (typically to 160° C. or higher, for example 200° C. or higher) due to an internal short circuit or the like. In other words, it is preferable for the melting temperature of the separator to be 160° C. or higher (and preferably 200° C. or higher).

The non-aqueous electrolyte typically has a constitution whereby a supporting electrolyte is dissolved or dispersed in a non-aqueous solvent. The supporting electrolyte is not particularly limited as long as a charge carrier (for example, lithium ions, sodium ions, magnesium ions, or the like; lithium ions in the case of a lithium ion secondary battery) is contained therein, and the supporting electrolyte can be similar to those used in ordinary non-aqueous electrolyte secondary batteries. For example, in cases where the charge carrier is lithium ions, examples of the supporting electrolyte include lithium salts such as LiPF₆, LiBF₄ and LiClO₄. This type of supporting electrolyte may be a single supporting electrolyte or a combination of two or more types thereof. A particularly preferred example of a supporting electrolyte is LiPF₆. In addition, it is preferable to adjust the concentration of the supporting electrolyte, relative to the overall non-aqueous electrolyte, from 0.7 mol/L to 1.3 mol/L.

The non-aqueous solvent is not particularly limited, and can be an organic solvent such as a carbonate compound, an ether compound, an ester compound, a nitrile compound, a sulfone compound or a lactone compound, which are used in electrolyte solutions in ordinary non-aqueous electrolyte secondary batteries. In a preferred aspect, a non-aqueous solvent consisting mainly of a carbonate compound is used. Specifically, ethylene carbonate (EC), propylene carbonate (PC), diethyl carbonate (DEC), dimethyl carbonate (DMC), ethyl methyl carbonate (EMC), or the like can be advantageously used.

In a preferred aspect, a gas generating agent is contained in addition to the above-mentioned supporting electrolyte and non-aqueous solvent. The gas generating agent is an additive which undergoes oxidative decomposition at the cathode and generates a gas when the voltage exceeds a prescribed value. The gas generating agent is not particularly limited as long as this is a compound which has an oxidation potential (vs. Li/Li⁺) that is not lower than the upper limit of the charging potential of the cathode and which generates a gas through decomposition in cases where this potential is exceeded (in cases where the battery is in an overcharged state), and it is possible to use one or more agents selected from among agents used for similar applications. Specifically, the gas generating agent can be an aromatic compound such as a biphenyl compound, an alkylbiphenyl compound, a cycloalkyl benzene compound, an alkylbenzene compound, an organophosphorus compound, a fluorine-substituted aromatic compound, a carbonate compound or an aromatic hydrocarbon. More specific examples of such compounds (abbreviations of the compounds and the approximate oxidation potentials (vs. Li/Li⁺) of these compounds are shown in brackets) include biphenyl (BP; 4.4 V), cyclohexylbenzene (CHB; 4.6 V), methylphenyl carbonate (MPhC; 4.8 V) and ortho-terphenyl (OTP; 4.3 V). Moreover, the oxidation potentials of these compounds can be measured by means of a measurement method that uses a conventional publicly available three electrode type cell.

The type of gas generating agent to be used should be decided by taking into account, for example, the type of cathode active substance, the operating voltage of the battery, the above-mentioned capacity ratio (Ca/Cc), and so on. In a preferred aspect, the oxidation potential of the gas generating agent is adjusted so that the gas generating, agent decomposes and a gas is generated when the SOC of the battery is not lower than 115% and not higher than 140%. By setting a SOC of not lower than 115% (for example, not lower than 120%), the gas generating agent can be prevented from reacting when the battery is operating under normal usage conditions. Therefore, it is possible to achieve high durability (for example, excellent cycle characteristics and high temperature storage properties). In addition, by setting a SOC of not higher than 140%, it is possible to generate a gas rapidly during the initial stage of overcharging. Therefore, it is possible for the CID to deploy rapidly and therefore possible to increase the reliability of the battery.

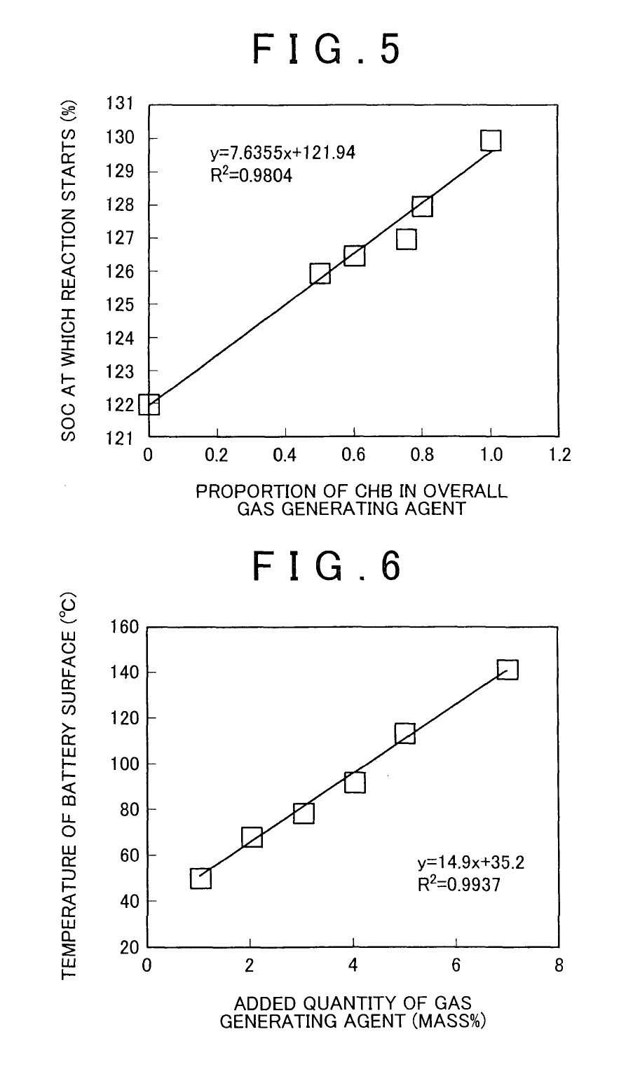

According to the findings of the inventor, the SOC at which the gas generating agent starts to react (the reaction initiation potential, typically the oxidation potential) can be adjusted by mixing two or types of gas generating agent having different oxidation potentials. For example, FIG. 5 shows a case in which CHB and BP are used. In FIG. 5, the horizontal axis shows the proportion of CHB if the total quantity of the gas generating agent (added quantity of CHB+added quantity of BP) is taken to be 1, and the vertical axis shows the SOC (%) at which the gas generating agent starts to react. That is, only BP is used when the proportion of CHB is 0.0, only CHB is used when the proportion of CHB is 1.0, and a mixture of CHB and BP is used at values between 0.0 and 1.0. As shown here, by mixing CHB and BP at prescribed proportions, the SOC at which the gas generating agent starts to react can be adjusted between approximately 120% and 130%. In other words, the oxidation potential (vs. Li/Li⁺) at the start of the reaction can be arbitrarily adjusted between approximately 4.4 V and 4.6 V. Similarly, in cases where a gas generating agent whereby the SOC at which the gas generating agent starts to react exceeds 130% is required, a gas generating agent having an oxidation potential higher than that of CHB or BP (for example, MPhC) should be additionally used. In cases where a gas generating agent whereby the SOC at which the gas generating agent starts to react is 120% or lower is required, a gas generating agent having an oxidation potential lower than that of CHB or BP (for example, OTP) should be additionally used. In this way, the SOC at which the gas generating agent starts to react can be adjusted relatively simply by altering the mixing ratio of two or more types of gas generating agent having different oxidation potentials.

In a preferred aspect, the above-mentioned charging capacity ratio of the anode and cathode (Ca/Cc) and the SOC (%) at which the gas generating agent starts to react satisfy the relationship: (SOC (%) at which the gas generating agent starts to react+5(%))/100≦(Ca/Cc). More specifically, in cases where a gas generating agent that starts to react at an SOC of, for example, 115% is used, it is preferable to include a 5% margin and set the charging capacity ratio of the anode and cathode (Ca/Cc) to be 1.20 or higher. In addition, in cases where a gas generating agent that starts to react at an SOC of 140% is used, it is preferable to include a 5% margin and set the charging capacity ratio of the anode and cathode (Ca/Cc) to be 1.45 or higher. By including a margin of 5% (preferably 10% or higher, and more preferably 15% or higher) in this way, it is possible to preferentially oxidatively decompose the gas generating agent at the cathode before the non-aqueous electrolyte is reductively decomposed at the anode. Therefore, the gas generating agent reacts efficiently during overcharging and a large quantity of gas can be rapidly generated.

The added quantity of the gas generating agent is not particularly limited, but should be approximately 0.05 mass % or higher, and preferably 0.1 mass % or higher, relative to 100 mass % of the non-aqueous electrolyte from the perspective of ensuring a sufficient quantity of gas to deploy the overcharging prevention device. However, because the gas generating agent can be a component that causes resistance to the battery reaction, the input-output characteristics can deteriorate if the added quantity of the gas generating agent is excessive. In addition, because gas generating agents are typically non-polar, layer separation can occur in polar non-aqueous solvents. Furthermore, according to the findings of the inventor of this invention, the temperature inside the battery can rise if the oxidative decomposition reaction occurs instantaneously upon overcharging. FIG. 6 is a graph in which the horizontal axis shows the added quantity (mass %) of the gas generating agent and the vertical axis shows the surface temperature (° C.) of the battery. Specifically, 6 types of battery were constructed, wherein the only difference was the added quantity of gas generating agent, and the surface temperature of the batteries was measured when overcharging tests were carried out. According to investigations by the inventor, if the surface temperature of the battery exceeds 130° C., the central part of the electrode body can locally reach a temperature that at least as high as the melting temperature of the separator (for example, 160° C.), although this can vary according to the capacity of the battery, the thickness of the electrode body, and so on. If the separator melts and the insulation function is lost, the anode and cathode can short circuit and the temperature inside the battery can rise. From this perspective, the added quantity of the gas generating agent is approximately 5 mass % or lower, and preferably 4 mass % or lower, relative to 100 mass % of the non-aqueous electrolyte.

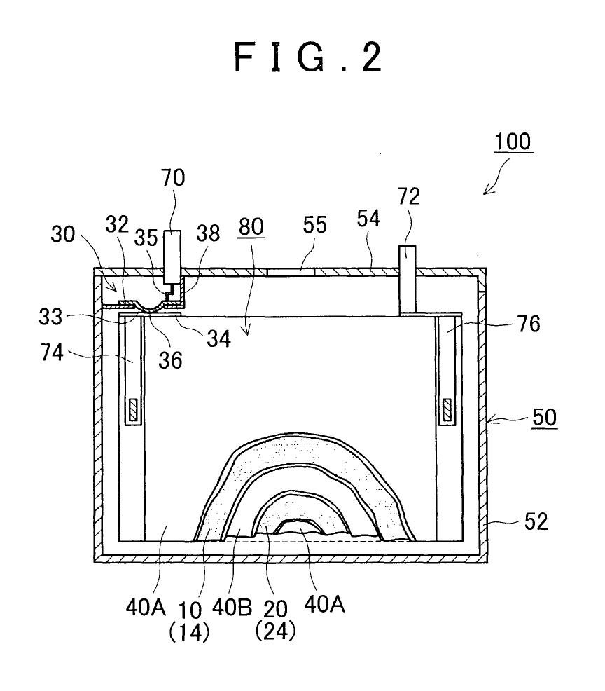

Although not intended to be a particular limitation, this invention will now be explained in detail by using the non-aqueous electrolyte secondary battery (single cell) shown schematically in FIG. 2 as an example of the configuration of a non-aqueous electrolyte secondary battery according to one embodiment of this invention. In the drawings shown below, members and parts having the same action are given the same reference symbols, and duplicate explanations may be omitted or simplified. Dimensions shown in the drawings (lengths, widths, thicknesses, and so on) do not necessarily reflect actual dimensions.

A non-aqueous electrolyte secondary battery 100 shown in FIG. 2 has a constitution whereby an electrode body (a wound electrode body) 80, which is obtained by flatly winding a cathode sheet 10 and an anode sheet 20 via two separators 40A and 40B, is housed in a flat box-shaped battery case 50 together with a non-aqueous electrolyte (not shown).

The battery case 50 includes a flat rectangular (box-shaped) battery case main body 52, the top of which is open, and a lid 54 that seals this open part. The upper surface (that is, the lid 54) of the battery case 50 is provided with a cathode terminal 70 for external connections, which is electrically connected to the cathode of the wound electrode body 80, and an anode terminal 72 that is electrically connected to the anode of the wound electrode body 80. The lid 54 also includes a safety valve 55 for discharging gas generated inside the battery case 50 to outside the battery case 50, in the same way as a battery case for a conventional non-aqueous electrolyte secondary battery.

A current interrupt device 30 that deploys when the pressure inside the battery case increases is provided inside the battery case 50. The current interrupt device 30 cuts an electrically conductive path from at least one of the electrode terminals to the electrode body 80 (for example, the charging path) when the pressure inside the battery case 50 increases, and is not particularly limited in terms of form. For example, in the aspect shown in FIG. 2, the current interrupt device 30 is provided between the cathode terminal 70, which is fixed to the lid 54, and the electrode body 80, and is configured so that the electrically conductive path between the cathode terminal 70 and the electrode body 80 is cut when the pressure (gas pressure) inside the battery case 50 increases. Specifically, the above-mentioned current interrupt device 30 can include, for example, a first member 32 and a second member 34. In addition, when the pressure inside the battery case 50 increases, the first member 32 and/or the second member 34 (the first member 32 in this case) deforms and separates from the other member, thereby cutting the above-mentioned electrically conductive path. In this aspect, the first member 32 is a deforming metal plate and the second member 34 is a connecting metal plate that is joined to the above-mentioned deforming metal plate 32. The deforming metal plate (first member) 32 is in the shape of an arch in which the central part of the arch curves downwards, and the peripheral part thereof is connected to the lower surface of the cathode terminal 70 via a current collector lead terminal 35. In addition, the tip of a curved part 33 of the deforming metal plate 32 is joined to the upper surface of the connecting metal plate 34. A cathode current collector 74 is joined to the lower surface (back surface) of the connecting metal plate 34, and this cathode current collector 74 is connected to the cathode 10 of the electrode body 80. In this way, an electrically conductive path is formed from the cathode terminal 70 to the electrode body 80.

In addition, the current interrupt device 30 includes an insulating case 38, which is formed from a plastic or the like. The insulating case 38 is disposed so as to surround the deforming metal plate 32 and hermetically seals the upper surface of the deforming metal plate 32. The pressure inside the battery case 50 does not act on the upper surface of this hermetically sealed curved part 33. In addition, the insulation in case 38 has an opening part that impacts upon the curved part 33 of the deforming metal plate 32, and the lower surface of the curved part 33 is exposed to the inside of the battery case 50 via this opening part. The pressure inside the battery case 50 acts on the lower surface of the curved part 33 that is exposed to the inside of the battery case 50. The configuration of this current interrupt device 30 is such that if the pressure inside the battery case 50 increases, the pressure acts on the lower surface of the curved part 33 of the deforming metal plate 32 and the downward curving curved part 33 is pushed upwards. The degree to which this curved part 33 is pushed upwards increases as the pressure inside the battery case 50 increases. In addition, if the pressure inside the battery case 50 exceeds a pre-set pressure, the curved part 33 becomes inverted and the curved part is deformed so as to curve upwards. When the curved part 33 deforms in this way, the junction 36 between the deforming metal plate 32 and the connecting metal plate 34 is broken. In this way, the electrically conductive path between the cathode terminal 70 and the electrode body 80 is cut and the overcharging current is interrupted. Moreover, the current interrupt device 30 is not limited to the cathode terminal 70 side, and may also be provided on the anode terminal 72 side. In addition, the current interrupt device 30 is not limited to mechanical interruption caused by the deformation of the deforming metal plate 32 described above, and it is also possible to provide, for example, an external circuit whereby the pressure inside the battery case 50 is detected by a sensor and the charging current is interrupted if the pressure detected by the sensor exceeds a pre-set pressure, as a current interrupt device.

The flat wound electrode body 80 is housed inside the battery case 50 together with a non-aqueous electrolyte (not shown). The wound electrode body 80 includes the long sheet-like cathode (cathode sheet) 10 and the long sheet-like anode (anode sheet) 20 in an initial assembly stage. The cathode sheet 10 includes a long cathode current collector and a cathode active substance layer 14, which is provided on at least one surface (and typically both surfaces) of the long cathode current collector and which is formed in the length direction of the long cathode current collector. The anode sheet 20 includes a long anode current collector and an anode active substance layer 24, which is provided on at least one surface (and typically both surfaces) of the long anode current collector and which is formed in the length direction of the long anode current collector. In addition, an insulating layer that prevents direct contact between the cathode active substance layer 14 and the anode active substance layer 24 is provided between the cathode active substance layer 14 and the anode active substance layer 24. Here, two long sheet-like separators 40A and 40B are used as the above-mentioned insulating layer. This type of wound electrode body 80 can be produced by winding a laminate obtained by, for example, overlaying the cathode sheet 10, the separator sheet 40A, the anode sheet 20 and the separator sheet 40B in that order in the length direction, and squeezing the obtained wound body from the sides so as to form a flat shape.

A tightly laminated wound core part, which is obtained by overlaying the cathode active substance layer 14 formed on the surface of the cathode current collector and the anode active substance layer 24 formed on the surface of the anode current collector, is formed in the central part in the width direction, which is specified as the direction from one edge towards the other edge in the winding axis direction of the wound electrode body 80. In addition, a part in which the cathode active substance layer is not formed on the cathode sheet 10 and a part in which the anode active substance layer is not formed on the anode sheet 20 protrude outwards from the wound core part at both edges of the wound core part in the winding axis direction of the wound electrode body 80. In addition, the cathode current collector 74 is provided on the protruding part on the cathode side, the anode current collector 76 is provided on the protruding part on the anode side, and the cathode terminal 70 is electrically connected to the anode terminal 72.

The non-aqueous electrolyte secondary battery 100 having this configuration can be constructed by placing the wound electrode body 80 in the battery case 50 through the open part, attaching the lid 54 to the open part of the battery case 50, introducing the non-aqueous electrolyte via an electrolyte introduction hole (not shown) provided in the lid 54, and then sealing this introduction hole by means of welding or the like.

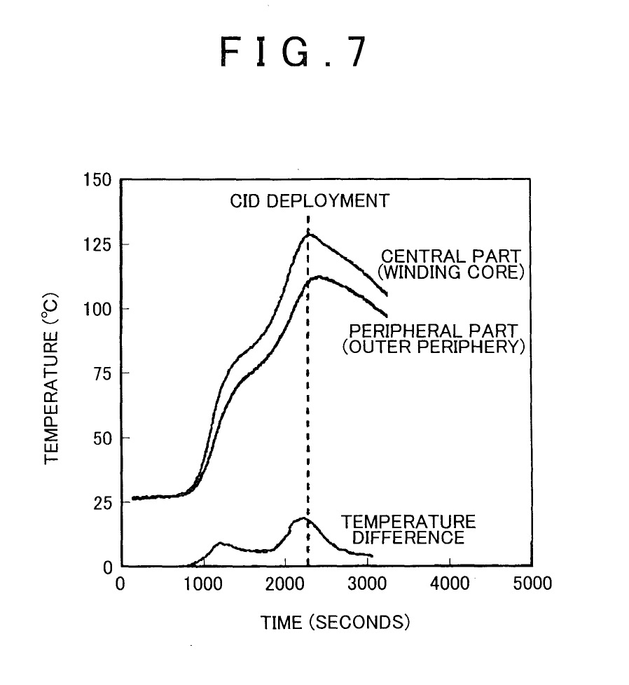

The non-aqueous electrolyte secondary battery disclosed here can achieve both excellent battery performance and reliability (resistance to overcharging) at high levels. Therefore, examples of preferred applications for this invention include secondary batteries having large capacities (for example, a battery capacity of 20 Ah or higher, and typically 25 Ah or higher, for example 30 Ah or higher) and secondary batteries having thick electrode bodies (for example, a battery in which the thickness T of the flat part of the wound electrode body is 10 mm or more (typically 20 mm or more) and less than 45 mm (typically 40 mm or less)). According to the findings of the inventor of this invention, the temperature difference inside the electrode body during overcharging can increase in an electrode body in which the thickness T of the flat part of the wound electrode body is 20, mm or higher. For example, the difference in temperature between the central part of a wound electrode body (a winding core) and the peripheral part (the outer periphery) of the wound electrode body can reach a maximum of approximately 20° C., as shown in FIG. 7. For example, even if the temperature inside the battery rises during overcharging and the separator in the peripheral part of the electrode body reaches the shutdown temperature, the separator near the center of the wound electrode body can melt and the insulating function can be lost. In such cases, the temperature of the battery increases due to a short circuit between the cathode and anode. Therefore, in this type of large size or large capacity battery, measures designed to deal with overcharging (for example, attaching the CID to the battery case) are particularly important. According to the features disclosed here, it is possible to achieve both battery characteristics during normal usage and reliability during overcharging (resistance to overcharging) at high levels.

In a preferred aspect, the energy capacity (Wh/mm) relative to the thickness of the electrode body, which is calculated by dividing the energy capacity of the battery (Wh) by the thickness T of the flat part (mm), is 4.4 Wh/mm or lower (for example, 4.2 Wh/mm or lower). According to investigations by the inventor, by setting the range mentioned above, it is possible to suppress an increase in temperature (the quantity of heat generated) in a nail penetration test and further improve resistance to internal short circuits.

The non-aqueous electrolyte secondary battery disclosed here can be used in a variety of applications; but is characterized by being able to achieve superior battery characteristics to conventional batteries (for example, being able to achieve both input-output characteristics across a wide range of SOC regions and durability at high levels). In addition, the non-aqueous electrolyte secondary battery disclosed here can achieve both excellent battery performance and reliability (resistance to overcharging and resistance to internal short circuits) at high levels. Therefore, by making use of such characteristics, the non-aqueous electrolyte secondary battery disclosed here can be advantageously used in applications that require high energy density or high input-output density and applications that require high reliability. Examples of such applications include motive power sources fitted to vehicles such as plug-in hybrid vehicles, hybrid vehicles and electric vehicles. Moreover, this type of secondary battery is typically used in the form of a battery pack in which a plurality of batteries are connected in series and/or in parallel.

A number of working examples relating to this invention will now be explained, but this invention is in no way limited to these specific examples.

(Construction of lithium ion secondary battery) First, spherical non-crystalline carbon-coated graphites C1 to C10 that satisfied the relationship log(R×S_{BET}) shown in Table 1 were prepared as anode active substances. Moreover, R denotes the R-value obtained by means of Raman spectroscopy. In addition, S_{BET} denotes the BET specific surface area (m²/g) obtained by means of a nitrogen adsorption method. Next, a slurry-like composition was prepared by mixing this anode active substance, a styrene-butadiene rubber as a binder and carboxymethyl cellulose as a dispersing agent at a mass ratio of 99:0.5:0.5 in ion exchanged water. This composition was coated on both sides of a copper foil (an anode current collector) having a thickness of 10 μm, dried and then pressed so as to produce anode sheets C1 to C10 having the anode active substance layer on the anode current collector.

Next, the unit irreversible capacity per 1 g of this anode active substance was measured. Specifically, the anode sheets C1 to C10 produced as described above were first cut to sizes of □45 mm×47 mm. A laminate (electrode body) was then produced by disposing this anode sheet so as to face a metallic lithium sheet (measuring □47 mm×49 mm) via a separator (here, the separator was a polyethylene separator having a porous heat-resistant layer on one side thereof). This laminate was then housed in a laminated case, and a non-aqueous electrolyte (here, the non-aqueous electrolyte was one obtained by dissolving LiPF₆ as a supporting electrolyte at a concentration of 1.1 mol/L in a mixed solvent containing ethylene carbonate (EC), dimethyl carbonate (DMC) and ethyl methyl carbonate (EMC) at an EC:DMC:EMC volume ratio of 30:40:30) was introduced into the case. Next, laminated sheet type two electrode cells C1 to C10 were constructed by heat sealing the opening in the laminate sheet under vacuum. The cell was then subjected to a charging and discharging test such as that described above at a temperature of 25° C., and the unit irreversible capacity of the anode (mAh/g) was determined. The results are shown in the corresponding column in Table 1.

Next, a slurry-like composition was prepared by mixing a LiNi_{0.38}Co_{0.32}Mn_{0.30}O₄ powder as a cathode active substance, acetylene black as an electrically conductive material and poly(vinylidene fluoride) as a binder at a mass ratio of 94:3:3 in N-methylpyrrolidone. This composition was coated on both sides of a long aluminum foil (a cathode current collector) having a thickness of 15 μm, dried and then pressed so as to a produce cathode sheet having the cathode active substance layer on the cathode current collector.

Next, the unit irreversible capacity per 1 g of this cathode active substance was measured. Specifically, the cathode sheet produced as described above was first cut to a size of □45 mm×47 mm. A laminate (electrode body) was then produced by disposing this cathode sheet so as to face a metallic lithium sheet (measuring □47 mm×49 mm) via a separator (here, the separator was a polyethylene separator having a porous heat-resistant layer on one surface thereof). This laminate was then housed in a laminated case, and a non-aqueous electrolyte (here, the non-aqueous electrolyte was one obtained by dissolving LiPF₆ as a supporting electrolyte at a concentration of 1.1 mol/L in a mixed solvent containing ethylene carbonate (EC), dimethyl carbonate (DMC) and ethyl methyl carbonate (EMC) at an EC:DMC:EMC volume ratio of 30:40:30) was introduced into the case. Next, a laminated sheet type two electrode cell was constructed by heat sealing the opening in the laminate sheet under vacuum. The cell was then subjected to a charging and discharging test such as that described above at a temperature of 25° C., and the unit irreversible capacity of the cathode (mAh/g) was determined. The irreversible capacity of the anode Ua (mAh) in the above-mentioned anode sheets C1 to C10 was then calculated from the product of the unit irreversible capacity of the anode (mAh/g) and the mass (g) of the anode active substance. Similarly, the irreversible capacity of the cathode Uc (mAh) in the above-mentioned cathode sheet was then determined from the product of the above-mentioned unit irreversible capacity of the cathode (mAh/g) and the mass (g) of the cathode active substance. Ua and Uc were then compared. The magnitude correlation between Ua and Uc is shown in the corresponding column in Table 1.

Next, the anode sheets C1 to C10 produced as described above were laminated in such a way as to face the cathode sheet produced as described above via two separator sheets. Each of the separator sheets had a configuration whereby an alumina-containing heat-resistant layer was provided on a single layer of polyethylene (PE). 10 flat wound electrode bodies corresponding to anode sheets C1 to C10 were produced by winding this laminate in the length direction and then squeezing the obtained wound laminate from the sides. The charging capacity ratio of the cathode and anode (Ca/Cc) was calculated and the thickness (mm) of the flat part of the wound electrode body was measured for each of the laminates. The results are shown in the corresponding column in Table 1.

Next, the cathode terminal and anode terminal were attached to the lid of the battery case, and these terminals were welded to the cathode current collector exposed at the edge of the wound electrode body (the non-coated part of the cathode active substance layer) and the anode current collector exposed at the edge of the wound electrode body (the non-coated part of the anode active substance layer) respectively. In addition, a current interruption device such as that shown in FIG. 2 was provided between the cathode terminal and the wound electrode body. In this way, the wound electrode body connected to the lead was placed in the square aluminum battery case through the open part of the battery case, and the lid was then welded onto the open part.

Next, a non-aqueous electrolyte was prepared. That is, a non-aqueous electrolyte was prepared by dissolving LiPF₆ as a supporting electrolyte at a concentration of 1.1 mol/L in a mixed solvent containing ethylene carbonate (EC), dimethyl carbonate (DMC) and ethyl methyl carbonate (EMC) at an EC:DMC:EMC volume ratio of 30:40:30, and substances were prepared by incorporating gas generating agents of the types shown in Table 1 in the non-aqueous electrolyte at the proportions (mass %) shown in Table 1. Next, the non-aqueous electrolyte was introduced via an electrolyte introduction hole provided in the lid of the battery case, and the open part of the battery case was hermetically sealed. In this way, three units each of square lithium ion secondary batteries (Examples 1 to 10) were constructed.

TABLE 1

| | Configuration of wound electrode body | | | | | |
|---|---|---|---|---|---|---|
| | Anode | | | Capacity | | |
| | active substance | | Irreversible | ratio of | | Energy |
| | | Unit irreversible | capacity of | anode and | Electrode | capacity relative to |
| | log | capacity | anode and | cathode | body thickness | electrode body |
| | (R × SBET) | (mAh/g) | cathode | (Ca/Cc) | (mm) | thickness (Wh/mm) |
| Example 1 | 0.17 | 34 | Ua > Uc | 1.32 | 24 | 3.9 |
| Example 2 | 0.17 | 34 | Ua > Uc | 1.35 | 24 | 3.9 |
| Example 3 | 0.04 | 22 | Ua > Uc | 1.25 | 24 | 3.9 |
| Example 4 | 0.12 | 30 | Ua > Uc | 1.45 | 20 | 4.4 |
| Example 5 | 0.04 | 22 | Ua > Uc | 1.25 | 35 | 2.4 |
| Example 6 | 0.04 | 22 | Ua > Uc | 1.25 | 24 | 3.9 |
| Example 7 | 0.17 | 34 | Ua > Uc | 1.35 | 45 | 4.7 |
| Example 8 | 0.31 | 48 | Ua > Uc | 1.35 | 24 | 3.9 |
| Example 9 | 0.17 | 34 | Ua > Uc | 1.35 | 24 | 3.9 |
| Example 10 | 0.04 | 15 | Ua < Uc | 1.25 | 24 | 3.9 |

| | | | | Battery performance | | | |
|---|---|---|---|---|---|---|---|
| | | | | evaluation results | | | |
| | | | | Capacity | | Durability | |
| | | | | retention | | evaluation results | |
| | | | | rate (%) | | | Internal |
| | Gas generating agent | | | after | | | short |
| | | | SOC | storage | IV resistance | | circuit |
| | | | at which | for 100 | at 25° C. | Overcharging | Nail |
| | | | reaction | days | at 20% SOC | CID | penetration |
| | (1) | (2) | starts (%) | at 60° C. | (mΩ) | deployment | test |
| Example 1 | CHB | BP | 128 | 93 | 2.01 | ∘ | ∘ |
| | (4 mass %) | (1 mass %) | | | | | |
| Example 2 | CHB | — | 130 | 92 | 2.21 | ∘ | ∘ |
| | (5 mass %) | | | | | | |
| Example 3 | — | BP | 122 | 95 | 2.05 | ∘ | ∘ |
| | | (4 mass %) | | | | | |
| Example 4 | CHB | MPhC | 140 | 91 | 2.00 | ∘ | ∘ |
| | (2 mass %) | (3 mass %) | | | | | |
| Example 5 | BP | OTP | 115 | 95 | 2.11 | ∘ | ∘ |
| | (2 mass %) | (2 mass %) | | | | | |
| Example 6 | CHB | BP | 128 | 95 | 2.11 | x | ∘ |
| | (4 mass %) | (1 mass %) | | | | | |
| Example 7 | CHB | BP | 128 | 92 | 2.21 | x | x |
| | (4 mass %) | (1 mass %) | | | | | |
| Example 8 | CHB | BP | 128 | 84 | 2.11 | ∘ | ∘ |
| | (4 mass %) | (1 mass %) | | | | | |
| Example 9 | — | — | — | 94 | 2.21 | x | ∘ |
| Example 10 | BP | OTP | 115 | 93 | 2.67 | ∘ | ∘ |
| | (2 mass %) | (2 mass %) | | | | | |

The lithium ion secondary batteries constructed as described above were charged. Specifically, at a temperature of 25° C., the above-mentioned battery was charged at a constant current of 1 C until the voltage between the cathode terminal and anode terminal reached 4.1 V (CC charging), then charged at a constant voltage until the total charging time reached 2.5 hours (CV charging), then allowed to rest for 10 minutes, discharged at a constant current of ⅓ C until the voltage between the cathode terminal and anode terminal reached 3.0 V (CC discharging), and then discharged at a constant voltage until the total discharging time reached 3 hours (CV discharging). The above-mentioned discharging capacity (CCCV discharging capacity) was recorded as the initial capacity. In addition, the energy capacity relative to the thickness of the electrode body (Wh/mm) was calculated by dividing the energy capacity at this point (Wh) by the measured thickness (mm) of the flat part of the electrode body. The results are shown in the corresponding column in Table 1.

Next, the SOC of the above-mentioned battery was adjusted to 20% at a temperature of 25° C. At a temperature of 25° C., this battery was subjected to CC discharging at a discharging rate of 10 C until the voltage reached 3 V, and the amount by which the voltage dropped in a period of 10 seconds from discharging was measured. The IV resistance (mΩ) was calculated by dividing this drop in voltage (mV) by the corresponding current (mA). The results are shown in the corresponding column in Table 1.

As shown in Table 1, Example 10 exhibited a high IV resistance value in a relatively low SOC region. This is thought to be because the irreversible capacity of the cathode Uc was greater than the irreversible capacity of the anode Ua (Uc>Ua), meaning that the changing voltage in the initial stage of discharging was dependent upon the cathode potential. As a result, it was understood that by making Uc<Ua, it is possible to achieve excellent input-output characteristics across a wide range of SOC regions (and in particular in a low SOC region).

Next, the above-mentioned battery was adjusted to a charged state having an SOC of 85% at a temperature of 25° C. This battery was stored for 100 days in a constant temperature chamber at 60° C. Next, the battery capacity following this high-temperature storage test was measured in the same way as for the above-mentioned initial capacity, and the capacity retention rate (%) was calculated from [(capacity after high-temperature storage/initial capacity)×100]. The results are shown in the corresponding column in Table 1.

As shown in Table 1, the high temperature storage properties of Example 8 were relatively poor. This is thought to be because the unit irreversible capacity of the anode was excessively high. As a result, it was understood that by setting the unit irreversible capacity of the anode to be not higher than 35 mAh/g, it is possible to achieve excellent durability (for example, high temperature storage properties). From these results, it was understood that by setting the unit irreversible capacity of the anode per 1 g of anode active substance to be not lower than 15 mAh/g and not higher than 35 mAh/g and by setting the irreversible capacity of the anode Ua (mAh) and the irreversible capacity of the cathode Uc (mAh) to be such that Uc<Ua, it is possible to obtain a battery which exhibits both excellent input-output characteristics in a low SOC region and high durability.

Furthermore, the above-mentioned battery was adjusted to a charged state having an SOC of 100% (fully charged state) at a temperature of 25° C. and then subjected to an overcharging test. The behavior of this battery was observed when the battery was continuously charged at a constant current of 1 C until any one of (1) to (3) described below occurred, and then further forcibly charged. (1) The SOC reached 200%, (2) the battery voltage (the difference between the cathode potential and of the anode potential) reached 5 V, or (3) the CID deployed, and the results are shown in the corresponding column in Table 1. In Table 1, cases in which the test was terminated as a result of (3), that is, cases in which the CID deployed safely, are shown as “o”, and cases other than these are shown as “x”.

As shown in Table 1, Example 9 did not contain a gas generating agent, and the CID did not therefore deploy. In addition, the CID did not deploy in Example 6 or Example 7. In Example 6; the SOC at which the gas generating agent starts to react and the charging capacity ratio between the cathode and the anode (Ca/Cc) did not satisfy the following relationship: (SOC at which the gas generating agent starts to react+5)/100≦(Ca/Cc). As a result, it is thought that lithium precipitated on the surface of the anode during overcharging and reductive decomposition of the non-aqueous electrolyte occurred, meaning that the gas generating agent hardly decomposed and the pressure increase width inside the battery was low. In Example 7, meanwhile, the electrode body was thick, meaning that temperature unevenness occurred inside the battery. As a result, it is thought that localized melting of the separator occurred and another condition for terminating the test occurred before the CID deployed. From these results, it was understood that if the SOC at which the gas generating agent starts to react and the charging capacity ratio between the cathode and the anode (Ca/Cc) satisfy the following relationship: (SOC at which the gas generating agent starts to react+5)/100≦(Ca/Cc), it is possible to obtain a battery having excellent resistance to overcharging and thermal, stability. For example, it was understood that if the SOC at which the gas generating agent starts to react is not lower than 115% and not higher than 140%, the relationship 1.2≦(Ca/Cc)≦1.5 is satisfied and it is possible to obtain a battery having excellent resistance to overcharging and thermal stability.

Next, the above-mentioned battery was adjusted to a charged state having an SOC of 80% at a temperature of 25° C. and subjected to a nail penetration test. Specifically, two thermocouples were attached to the outer surface of the battery case, and an iron nail having a diameter (Φ) of 6 mm and a tip sharpness of 30° was driven directly into the approximate center of the square battery case at a speed of 20 mm/sec at a temperature of 25° C. so that the nail penetrated the case. The change in temperature of the battery during this process was measured. The results are shown in the corresponding column in Table 1. In Table 1, one cases in which only smoke was emitted were recorded as “o”, and other cases in which a continuous increase in temperature was observed were recorded as “x”.

As shown in Table 1, Example 7 reached a thermally unstable condition. This is thought to be because the energy capacity relative to the thickness of the electrode body was high, meaning that the temperature increase width was high.

This invention was explained in detail above, but the embodiments shown above are merely exemplary, and the invention disclosed here includes embodiments obtained by variously modifying or altering the specific examples shown above.

The battery disclosed here is characterized by being able to achieve excellent input-output characteristics across a wide range of SOC regions. Therefore, by utilizing this characteristic, the battery disclosed here can be used particularly advantageously in applications that require, for example, input-output characteristics in a low SOC region. Examples of such applications include power sources (motive power sources) for motors fitted to vehicles such as plug-in hybrid vehicles, hybrid vehicles and electric vehicles.

1. A non-aqueous electrolyte secondary battery comprising:
an electrode body having a cathode and an anode, the cathode having a cathode active substance, the anode having an anode active substance, a unit irreversible capacity of the anode per 1 g of the anode active substance being within a range from 15 mAh/g to 35 mAh/g, a relationship between an irreversible capacity of the anode and an irreversible capacity of the cathode satisfying Uc<Ua,
where Ua is the irreversible capacity of the anode, which is a product of multiplying the unit irreversible capacity of the anode per 1 g of the anode active substance by a mass of the anode active substance, and
Uc is the irreversible capacity of the cathode, which is a product of multiplying a unit irreversible capacity of the cathode per 1 g of the cathode active substance by a mass of the cathode active substance;
a non-aqueous electrolyte; and
a battery case that houses the electrode body and the non-aqueous electrolyte.

2. The non-aqueous electrolyte secondary battery according to claim 1, wherein
a ratio of a charging capacity of the anode to a charging capacity of the cathode satisfies a following relationship: 1.2≦Ca/Cc≦1.5,
where Ca is the charging capacity of the anode, which is a product of multiplying a unit charging capacity of the anode per 1 g of the anode active substance by the mass of the anode active substance, and
Cc is the charging capacity of the cathode, which is a product of multiplying a unit charging capacity of the cathode per 1 g of the cathode active substance by the mass of the cathode active substance.

3. The non-aqueous electrolyte secondary battery according to claim 1, wherein
the battery case includes a current interrupt device that is configured to interrupt a current of the non-aqueous electrolyte secondary battery when a pressure inside the battery case exceeds a pre-set pressure, and
the non-aqueous electrolyte contains a gas generating agent capable of generating a gas through decomposition when a SOC of the battery is within a range from 115% to 140%.

4. The non-aqueous electrolyte secondary battery according to claim 1, wherein
the anode active substance is a particulate non-crystalline carbon-coated graphite, and properties of the anode active substance satisfies a following relationship: −0.03≦log(R×S_{BET})≦0.18,
where R is a R-value of the particulate non-crystalline carbon-coated graphite, as measured by Raman spectroscopy, and
S_{BET} is a BET specific surface area of the particulate non-crystalline carbon-coated graphite, as measured using a nitrogen adsorption method.

5. The non-aqueous electrolyte secondary battery according to claim 1, wherein
the electrode body is a flat wound electrode body, and
the thickness of a flat part of the wound electrode body is 20 mm or higher.
